(19) United States
(12) Patent Application Publication
(10) Pub. No.: US 2005/0262451 A1
(43) Pub. Date: Nov. 24, 2005

(54) Graphical user interface for changing parameters

(76) Inventors: Jesse Remignanti, Reading, MA (US); Camille Huin, Cambridge, MA (US); Miguel A. Chavez, Cambridge, MA (US)

Correspondence Address: John J. Stickevers;Bromberg & Sunstein LLP, 125 Summer Street, Boston, MA, 02110-1618, US

(21) Appl. No.: 10/953,405

(22) Filed: Sep. 29, 2004

Related U.S. Application Data
(60) Provisional application No. 60/509,981, filed on Oct. 9, 2003.

(51) Int. Cl. G06F 3/00

(52) U.S. Cl. 715/833; 715/716

(57) ABSTRACT

A computer program product and method for changing the value of a parameter within a computer program is disclosed. The computer program provides a single graphical control for user selection and adjustment of a plurality of parameters wherein each parameter is controlled based upon movement of a user input device. At least one of the parameters is adjusted using a non-linear equation. When the user input device is moved within a first region from a defined reference point, the parameter value is not incremented. When the user input device enters a second region the parameter value is incremented at a first rate. As the user input device is moved into a third region the parameter value is incremented at a second rate that is greater than the first rate.

### PRIORITY

The present U.S. patent application claims priority from U.S. Provisional Application No. 60/509,981, filed on Oct. 9, 2003 entitled “Graphical User Interface for an Equalizer,” which is incorporated herein by reference in its entirety.

### TECHNICAL FIELD

The present invention relates to graphical user interfaces and more specifically to a graphical control for changing a plurality of parameters.

### BACKGROUND ART

Audio engineers and the general public often adjust audio signals using equalizers. For example, a graphic equalizer presents the user with a set of predefined frequencies which can be changed. The user can boost or attenuate the amplitude of the audio signal at these predefined frequencies. This may be accomplished via a user interface that includes one or more sliders. Each slider is associated with one of the predefined frequencies and by moving the position of the slider the amplitude of the audio signal at that frequency is adjusted. In a computer system, a graphic equalizer can be represented visually on a display and controlled by an input device. Such a representation of a physical graphic equalizer operates in a similar fashion to a physical graphic equalizer wherein the amplitude of preset frequencies can be changed.

In contrast, a parametric equalizer permits the user to choose a particular frequency when adjusting an audio signal's frequency response. For instance, the user may be able to choose a frequency between 1 kHz and 10 kHz. Since the range of frequencies is quite large, but often must be fine tuned, the frequency at which the signal is to be modified is typically entered by a text based entry as opposed to a knob or other user interface when the parametric equalizer is employed in a computer system. For example, if the user interface includes a graphical display, the user will have to use an input device to select an input screen either by selecting a pull-down menu, through keyboard entry, or through clicking a mouse-like device. The user will then have to type in the frequency and then hit enter for the frequency to be selected. The user can then go back to the input device in order to adjust the amplitude of the frequency.

It would be preferable to have user interface in a computer environment that allows a user to adjust one or more parameters affecting the frequency response of the audio signal with a reduced number of operational steps and without having to switch between input devices (keyboard and mouse for example).

### SUMMARY OF THE INVENTION

One embodiment of the present invention is directed to a computer program product for use with a computer for changing a parameter that is displayed on a display device. A user of the computer program graphically selects a displayed user control for changing the parameter by engaging a selection input on a user input device. The user input device may be a mouse, a rollerball, or other device that interfaces with a computer and allows a user to make a selection graphically. The computer program uses a non-linear equation for determining how the parameter is incremented or decremented. The non-linear equation receives as its input physical movement of the user input device from a reference point. If the user input device is a mouse, the movement is the physical displacement of the mouse. If the user input device is a rollerball, the movement is the rotational movement of the ball.

The user moves the user input device a first distance from the reference point wherein the parameter does not increase. The user then continues to move the user input device in the same direction to at least a second distance from the reference point where the parameter is incremented by the computer program at a first rate. As the user continues to move the input device to at least a third distance from the reference point, the parameter begins to increment at a second rate that is faster than the first rate. Thus, if a user wishes to increment the parameter between two values, the user can move the device to the third distance and quickly increment to approximately the desired value and then can move the input device to the second distance and the user will have more precision as the device increments more slowly. If the user overshoots the desired value, the user can move the user input device in the opposite direction. At first the parameter will not increment until a second distance in the opposite direction from the reference point is reached. The parameter will then decrement slowly. If the user greatly overshoots the desired value the user can move the user input device to a third distance in from the reference point. The reference point may be indicated by selecting a button or other input on the user input device.

In one embodiment, the user holds a button down and moves the user input device across a surface. When the user releases the button, in such an embodiment, the reference point is reset. Once the reference point is reset, the user input device will need to move to at least the second distance from the reference point to increment the parameter.

The parameter that is being adjusted may be an audio parameter such as the frequency value for a parametric graphic equalizer. In such an embodiment, only a single displayed control and only a single user input device are needed to alter both the amplitude and the frequency. The user can select a slider control and control the amplitude by moving the user input device. The user can then select a portion of the displayed control and move the user input device to increment or decrement the frequency value. The frequency will be incremented or decremented based on a non-linear equation that is based on movement of the user input device. The user need not use a keyboard or numeric keypad. As the user moves the user input device to increment or decrement the frequency value, the computer program reacts to the movement much like a rubber band. At first, within a first region of movement of the user-input device, the frequency value stays constant. Once the user input device is moved at least a second distance from a reference point, the frequency increments at a first rate. After the user input device is moved to at least a third distance from the reference point, the frequency increments at a second rate that is faster than the first rate. Thus, within a first region there is no change in the frequency parameter. In a second region the frequency parameter increments at a slow rate and in the third region the frequency parameter increments at a rate that is faster than in the second region.

In certain embodiments, within a given region, the rate may vary depending upon the distance that is the user input device is moved, such that the distance from the reference point is proportional to the rate. When the user moves the input device between regions a new equation is used for determining the rate for incrementing the parameter value such that there is a discontinuity between the regions.

### BRIEF DESCRIPTION OF THE DRAWINGS

The foregoing features of the invention will be more readily understood by reference to the following detailed description, taken with reference to the accompanying drawings, in which:

FIG. 1 is a first example of a graphic equalizer wherein the frequency for each band may be changed;

FIG. 1A shows an input device and a screen shot with the various ranges for changing the frequency incrementing/decrementing rate;

FIGS. 2A-D show an example of one embodiment of the invention in which a single band notch filters is displayed in different windows as the amplitude and the frequency are adjusted;

FIG. 3 shows a graphical display in which a frequency response graph is presented to the user as changes are made to either the frequency or the amplitude;

FIG. 4 is a graphical display in which the slider adjusts amplitude at a particular frequency, and the frequency is changed by rotating the knob or the knob can be used for adjusting and visualizing a third parameter, like the Q factor of the filter;

FIG. 5 is a graphical display that shows an equalizer after user input selection wherein more controls in addition to the slider are presented to the user;

FIG. 6 is a graphical display that shows a horizontal as opposed to a vertical equalizer wherein frequency changes with the slider and amplitude is adjusted based upon input device movement;

### DETAILED DESCRIPTION OF SPECIFIC EMBODIMENTS

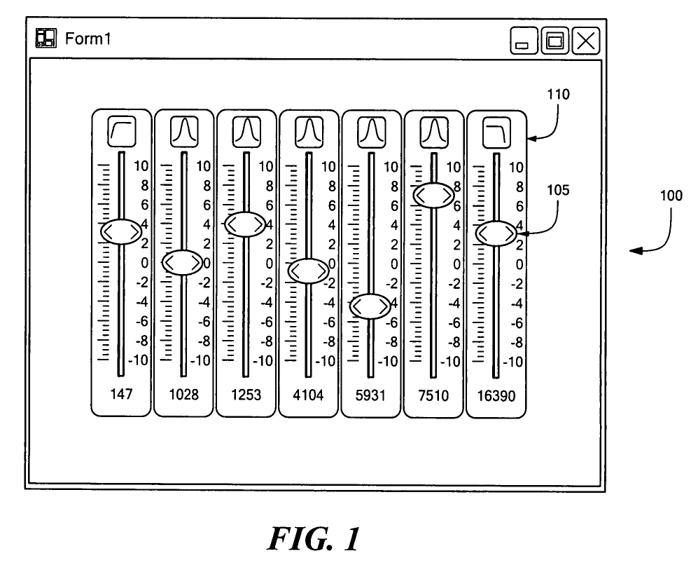

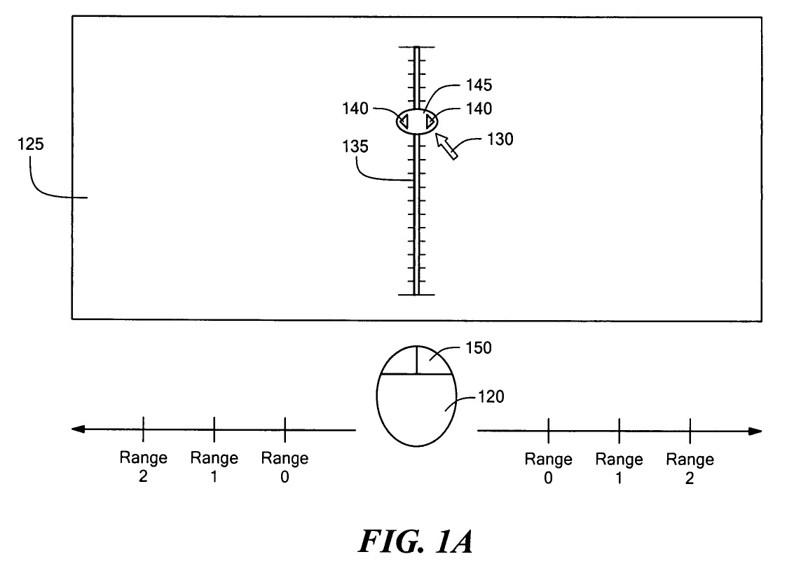

FIG. 1 is a first example of a graphic equalizer wherein the frequency for each band may be changed. This user interface allows the control of both frequency and amplitude in a slider control which reduces the amount of screen space as compared to prior art parametric equalizers. The user interface allows a user to switch control between different parameters without having to switch between input devices (mouse/trackball and keyboard) and with a reduced number of operations as compared to the prior art.

As shown in FIG. 1 a parametric equalizer 100 can be represented in a similar fashion to a standard graphic equalizer. In this case frequency adjustments for the various bands of the graphic equalizer can be made by clicking on the arrows 105 on the slider control 110. By selecting the arrows 105 and moving the input device the frequencies can be varied. The equation that is employed to translate input device movement to changes in frequency is a non-linear equation.

The non-linear equation operates like a rubber band for the frequency adjustment. As the user clicks on the arrow 105 and begins to move the input device (not shown) over a first predetermined distance the frequency stays constant at the initial frequency value. If the user moves the input device a bit more the frequency will slowly increment or decrement depending on the direction that the mouse is being moved in. The rate of change can be either a fixed or variable rate. In one embodiment, it is a fixed rate. As the user moves the input device further in a direction the frequency will increment or decrement much more rapidly. This solves one problem of frequency adjustment. In frequency adjustment, frequencies for a notch/low-pass/high-pass filter can be changed over a wide range of settings rapidly and precise adjustments can be made to the final frequency setting. This is superior to using a simple log-based equation for translating user input device movement. If a log scale is used for translating the input device movement, quick transitions can be made over the full range of frequencies by simply using the input device, but it is nearly impossible to stop on the desired frequency setting. For example, if a user wishes to change the setting of a notch filter from 147 Hz to 16,390 Hz and the frequency range varies between 0 Hz and 22 KHz, a log scale would allow the user to quickly move between 147 Hz and in the range of 16,000 Hz, but it would not allow the user to precisely stop on 16,390 Hz as desired.

With the non-linear equation that is proposed which acts like a rubber band, a user can move the input device a certain distance in the direction to increment the frequency and the frequency will quickly increase. As the user sees the frequency approaching the desired frequency range, the user can move the input device in the other direction and the frequency will increment at a much slower rate. If the user enters the center range, the frequency will neither increase or decrease. As the user moves in the other direction the frequency will at first slowly decrease. Using such a system, a user can quickly arrive at a desired frequency range near the desired frequency setting and then can fine tune the frequency without having to use a keyboard or perform multiple operations such as mouse clicks or button selections. The changes to the frequency are controlled through user movement of the input device in the case of a mouse or through user hand movement of a trackball. After the desired value is selected, the user can indicate that the value is set by selecting a button or other input on a user input device.

This graphical user interface and corresponding non-linear translation of physical movement of the user input device allows the user to quickly increment frequency over a wide frequency range, but provides precise adjustment of the final desired frequency. By minimizing the amount of information that is presented on the screen (i.e. not having to have a pop-up box for keyboard entry of a frequency) the user is provided with better visual feedback, and may view all of the parametric filters simultaneously. In FIG. 1 if the first filter is being adjusted, the user can still visually see the remaining filters and therefore knows what their settings are.

FIG. 1A shows an input device 120 and a screen 125 with a pointer/cursor 130 on the screen over a slider 135. In this configuration the slider controls the amplitude of the filter. The user can change the amplitude of the filter at any time by adjusting the slider up or down using the input device in conjunction with the cursor 130 that is provided on the screen 125. There is a relationship between the actual physical movement of the input device and the movement of the cursor on the screen. For example, there may be a 5:1 or 10:1 ration between actual physical movement of the input device and the cursor. The user can also select an arrow 140 on the slider control 145 by moving the pointer 130 over the arrow 140 on the slider control and using a selection button 150 on the input device. The user can then move the input device 120 to change the frequency. As the user moves the input device the frequency changes at different rates. As the user device is moved within Range 0, the frequency will not change. By moving the user device between range 0 and range 1 the frequency will increase very slowly so that a precise frequency can be selected. If the input device is moved between range 1 and range 2 the frequency will increase at a quicker rate than within range 1. As the user device is moved closer to range 2 the speed of change of the frequency will become greater. If the user input device is moved past the range 2 marker, the rate of change will saturate and thus will reach a threshold. This is implemented so that the rate changes are usable and the rate of change does not approach infinity or any unusable speed. In one embodiment, the speed of motion within range 1 to range 2 rather than the position of the user input device may control the rate of change of the frequency. As previously stated, there is a relationship between movement of the user input device and that of the cursor. The various ranges over which indicate changes in increment speed of the frequency may be controlled by a signal representative of the physical movement of the input device or the signal that is representative of the movement of the cursor on the screen. In certain embodiments, after the cursor 130 is used to select an arrow 140 on slider control 145 by selecting an input button 150, the cursor 130 does not move and therefore, the ranges are dictated by the physical movement of the input device 120. In other embodiments, the cursor will continue to move after selection of an arrow 140 and the signal which is indicative of the cursor movement on the screen can be used for designating the ranges.

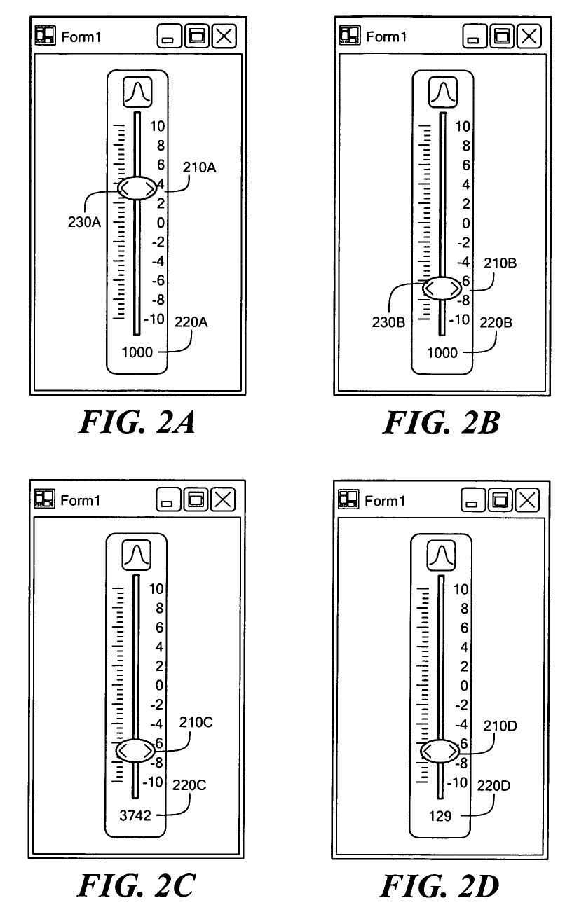

FIGS. 2A-D represent a single band notch filter through various changes to both the amplitude of the signal at the notch frequency and to the notch frequency itself. From left to right there are four states. The first state (FIG. 2A) shows the initial setting, where the notch filter is set at an amplitude 210A of a bit under 4 and at a frequency of 1000 Hz 220A. In the second window (FIG. 2B), the slider 230B has been moved and the amplitude 210B is changed to approximately −7. In the second window, the frequency 220B has not been changed. In the third window (FIG. 2C), the frequency 220C is changed to 3742 Hz and the amplitude 210C remains at approximately −7. In the fourth window (FIG. 2D), the frequency 220D is changed to 1291 Hz and the amplitude 210D remains at approximately −7. As explained above, the frequency is changed using the arrows on the slider and the amplitude is changed by sliding the slider up or down.

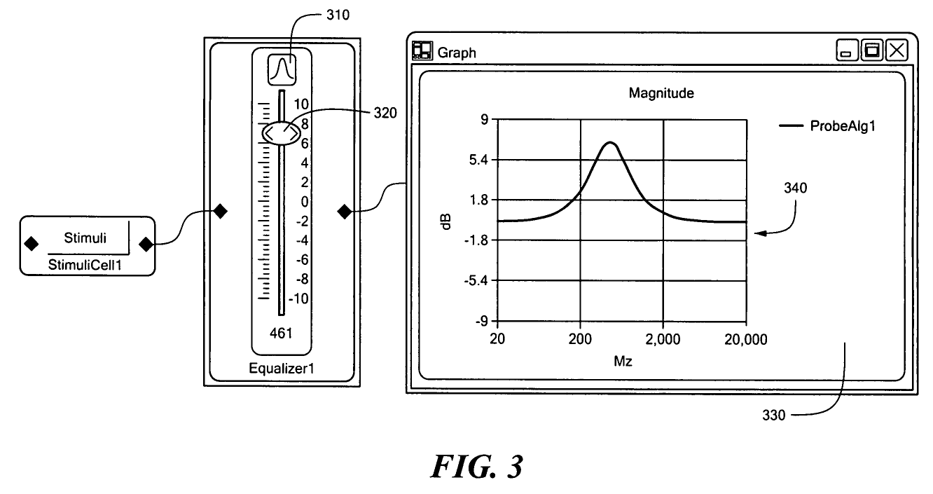

FIG. 3 shows an example of a notch filter 310 with a slider 320. In this embodiment, when the filter is selected, a window 330 pops up to provide visual feedback about the frequency response 340 of the filter. The user can then visually see how changes to the amplitude and to the frequency change in the frequency response. The pop up window 330 may simply show the frequency response of the filter, or it may show the result of the changes to an input signal. Further the pop up window may show the cumulative result of the changes provided by all of the filters to the input signal.

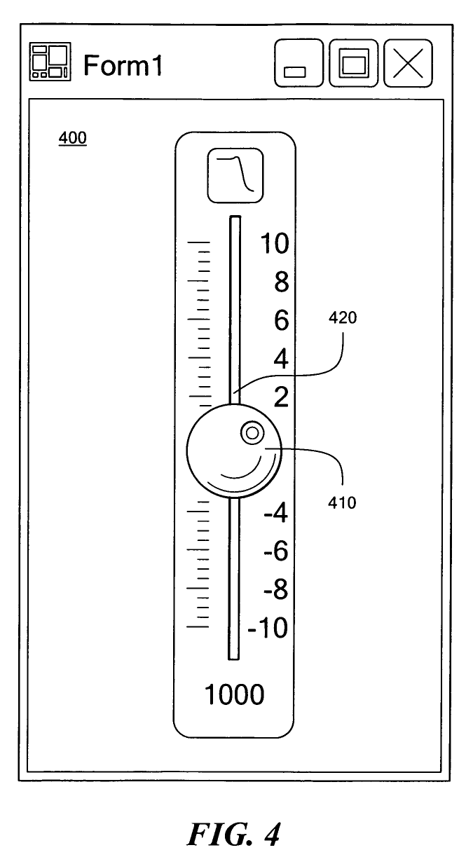

FIG. 4 is a graphical display 400 in which the slider 410 adjusts amplitude at a particular frequency and the frequency is changed by virtually rotating the knob 410 on the display. In a similar fashion to the non-linear rubber band effect that is described above with respect to the previous figures, selection of the knob 410 and virtually rotating the knob 410 by moving the user input device (not shown) causes the frequency to be changed. The frequency will increment or decrement depending on the direction of the rotation. In general practice a rotation to the right will cause an increment and rotating the knob to the left will cause the frequency to decrement. As the knob is rotated from the middle point 420 through a first predetermined angle of rotation, the frequency does not increment. If the knob is rotated further, into a range of rotational angles, the frequency begins to increment slowly and as the knob is rotated further the values the frequency increments more rapidly. As the user rotates the knob in the opposite direction, the frequency will slow in incrementing or decrementing so that the user can more precisely set the frequency. In the embodiment that is shown, a low-pass filter is provided, but any type of filter may be used with any of the disclosed embodiments including, but not limited to, high-pass filters, low-pass filters and notch filters.

In a further embodiment, the rotating knob may also include arrows (not shown). These arrows allow adjustment of the frequency as described above with respect to FIG. 1, in which the greater the movement away from the arrows the quicker the frequency will increment. In this embodiment, the rotating knob would adjust another parameter, such as, Q as is understood in the digital signal processing arts. Thus, a single slider type control configured as described allows for adjustment of three separate parameters.

Returning to FIG. 1, the arrows on the slider control are first selected by the input device through a selection process, such as, a mouse click. The user can then adjust the frequency. In one embodiment, the user is required to keep one of the input device buttons depressed while changing the frequency. In this embodiment, if the user stops depressing the button (such as the right mouse button on a two button mouse), the movement equation will be reset and the frequency will stop incrementing. It will appear to the user that the mouse has returned to the central position (within Range 0 of FIG. 1A). If the user then depresses the button again and begins to move the mouse, at first the frequency will not increment, as the user moves the mouse further in the direction to increment the frequency the frequency will slowly increment, as the user moves the mouse further the frequency will increment more rapidly. As the user continues to move the mouse further in the direction for incrementing the frequency, the frequency will continue to increment more and more rapidly. In one embodiment, there is a threshold above which movement of the input device will not cause the frequency to increment any faster, as such there is a saturation threshold based on the movement of the input device for the incremental speed.

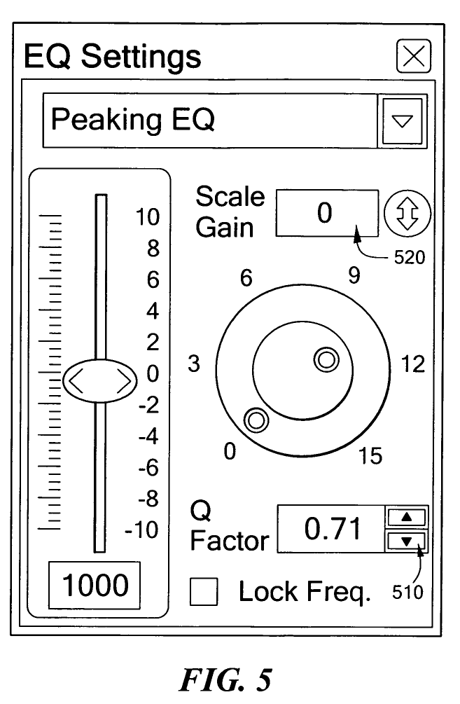

FIG. 5 is a graphical display of another embodiment of the invention showing a display screen that results after the user has clicked on the slider control. When the user clicks on the slider, the graphic changes from just a slider and provides more controls for changing other parameters. For example, the Q factor can by changed using arrow keys 510. Other factors such as the scale 520 may be incremented and decremented and the type of equalization filter may be selected and changed.

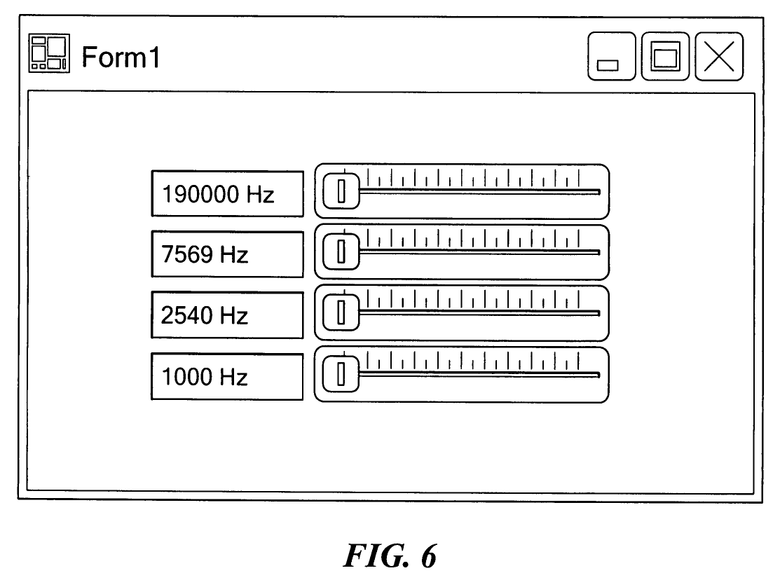

FIG. 6 is a graphical display that show a horizontal as opposed to a vertical equalizer wherein frequency changes with the slider and amplitude are adjusted based upon input device movement.

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

1. A computer program product having computer program code thereon for use with a processor, the computer code providing a graphical control for adjusting an audio signal with an input device, the computer code comprising:
computer code for providing a single graphical control wherein the graphical control allows for user selection of a plurality of parameters; and
computer code for providing adjustment of the plurality of parameters based on movement of the input device.

2. The computer program product according to claim 1 wherein the plurality of parameters include both amplitude and also frequency of a filter.

3. The computer program product according to claim 1, wherein the input device is a computer mouse.

4. The computer program product according to claim 1, wherein the input device is a trackball.

5. A computer program product having computer program code thereon for use with a processor, the computer code providing a graphical control for adjusting an audio signal with an input device, the computer code comprising:
computer code for ascertaining a physical displacement of the input device;
computer code for determining an output value based upon the physical displacement as an input parameter to a non-linear equation; wherein the output value is used to set an audio signal parameter.

6. The computer program product according to claim 5, wherein the non-linear equation includes different rates of incrementing the output value based upon the physical displacement of the input device.

7. The computer program product according to claim 6, wherein if the physical displacement of the input device from a reference point is within a first range, the output value does not increment.

8. The computer program product according to claim 7, wherein if the physical displacement of the input device from a reference point is within a second range, the output value increments at a first rate.

9. The computer program product according to claim 8, wherein if the physical displacement of the input device from a reference point is within a third range, the output value is incremented at a second rate that is greater than the first rate.

10. The computer program product according to claim 9, wherein within a given range the rates of incrementing the output value are constant.

11. The computer program product according to claim 5, wherein the audio signal parameter is a center frequency for a filter of the audio signal.

12. The computer program product according to claim 11 wherein the graphical control is a slider which allows for adjustment of the amplitude of the filter.

13. The computer program product according to claim 12, wherein the slider includes a frequency selector.

14. A computer program product having computer program code thereon for use with a processor, the computer code providing adjustment of a parameter, the computer code comprising:
computer code for determining a parameter based upon physical movement of an input device wherein if the movement of the input device is within a first region from a reference point the parameter is not incremented, if the movement of the pointing device is within a second region the parameter is incremented at a first rate and if the movement of the pointing device is within a third region the parameter is incremented at a second rate that is faster than the first rate.

15. The computer program product according to claim 14, wherein if the movement of the input device is outside of the third region the rate of increase of the parameter is set to a fixed finite value.

16. A method for changing a parameter within a computer program operating on a computer system with a user control displayed on a display device, the method comprising:
selecting a user control displayed on a display device by engaging a selection input on a user input device;
moving at least a portion of the user input device to at least a first distance from a reference point wherein the parameter does not increase, moving at least a portion of the user input device to at least a second distance from the reference point wherein the parameter increases at a first rate;
moving at least a portion of the user input device to at least a third distance from the reference point wherein the parameter increases at a second rate that is greater than the first rate.

17. A method for changing a parameter within a computer program according to claim 16, wherein the selection input must be engaged while at least a portion of the user input device is moved.

18. A method for changing a parameter within a computer program, according to claim 17, wherein if the selection input is not engaged while at least a portion of the user input device is moved the reference point is reset.

19. A method for changing a parameter within a computer program, according to claim 18, wherein if the reference point is reset the parameter will not increment until at least a portion of the user input device is moved at least the second distance from the reset reference point.
